(19) United States
(12) Patent Application Publication
(10) Pub. No.: US 2016/0295994 A1
(43) Pub. Date: Oct. 13, 2016

(54) COSMETIC VACUUM BOTTLE

(71) Applicant: EVER RICH FOUNTAIN ENTERPRISE CO., LTD., Taichung City (TW)

(72) Inventor: En-Hsin LIU, Taichung City (TW)

(21) Appl. No.: 14/681,112

(22) Filed: Apr. 8, 2015

(51) Int. Cl. A45D 40/00; B05B 11/00; B05B 11/02

(52) U.S. Cl. CPC A45D 40/0075; B05B 11/02; B05B 11/3042

(57) ABSTRACT

A cosmetic vacuum bottle includes: a bottle body with a mouth portion, a sealing member, a press member disposed at the mouth portion of the bottle body, and a piston being disposed in the bottle body. A first sealing surface of the sealing member is closely abutted against a first flat surface of the mouth portion to form a first sealing structure, a second sealing surface of the sealing member is abutted against an inner surface of the mouth portion to form a second sealing structure, and a third sealing surface is abutted against a pipe portion of the press member to form a third sealing structure. With the above three sealing structures, vacuum can be created in the bottle body simply by putting the sealing member and the press member to the mouth portion, without having to apply 10 kg torque.

### BACKGROUND OF THE INVENTION

1. Field of the Invention

The present invention relates to a bottle, and more particularly to a cosmetic vacuum bottle.

2. Description of the Prior Art

FIG. 1 shows a cosmetic vacuum bottle which comprises a bottle body 10, a gasket 20 and a press member 30. The bottle body 10 has a mouth 11 formed at one end and a bottom 12 at another end. At the bottom 12 is formed a vent hole 121. The gasket 20 is disposed on a first flat surface 111 of the mouth 11. The press member 30 is locked to the mouth 11. In the bottle body 10 is disposed a piston 13 to divide the bottle body 10 into an air space 14 and an airless vacuum space 15 which are located at both sides of the piston 13. The vent hole 121 is in communication with the air space 14. The piston 13 includes a sealing annular portion 131 which is closely abutted against the inner surface of the bottle body 10 to isolate the air space 14 from the vacuum space 15. The vacuum space 15 is filled with cosmetic products (in the form of liquid or powder or any other suitable forms), and the piston 13 is used to push the cosmetic products.

The gasket 20 is the only measure used to improve the airtight sealing property and vacuum of the bottle body 10, the gasket 20 can be flatly pressed against the first flat surface 111 of the mouth 11 to create a vacuum state only when the torque applied to the gasket 20 is 10 kilograms, and the 10 kg torque is usually applied by manual. Therefore, the airtight sealing property and the assembly quality are not easy to control. Manual operation is likely to cause poor airtight sealing, so that air will come into the bottle body 10 to spoil the cosmetic products contained therein.

Air is guided into the air space 14 of the bottle body 10 via the vent hole 121 defined at the bottom 12, and the sealing annular portion 131 of the piston 13 prevents air from coming into the vacuum space 15 from the air space 14, which produces a pressure difference to push the piston toward the vacuum space 15, so that the cosmetic products contained therein can be automatically pushed out without using suction pipe, there are no residues on the inner surface of the bottle body 10. When the airtightness is not maintained, air will come into the vacuum space 15 to reduce the pressure difference, which will adversely affect the effect of pushing the cosmetic products.

Or even worse, if the torque applied to the gasket 20 is less than 10 kg during the process of filling the bottle with cosmetic products, the gasket is susceptible to fatigue and becomes rigid, which will affect the airtightness of the vacuum bottle. Therefore, air will enter the vacuum space 15 via the mouth 11, so that the piston 13 can't work properly.

The present invention has arisen to mitigate and/or obviate the afore-described disadvantages.

### SUMMARY OF THE INVENTION

The primary objective of the present invention is to provide a cosmetic vacuum bottle which is easy to assemble, and equipped with multiple airtight sealing measurements to produce an improved airtight sealing effect.

To achieve the above objective, a cosmetic vacuum bottle in accordance with the present invention comprises:

a bottle body including a mouth portion at one end thereof, the mouth portion including an inner surface and an outer surface, the mouth portion having one end connected to the bottle body, and another end formed with a first flat surface, another end of the bottle body being a bottom surface on which being formed a vent hole;

a sealing member being a cylindrical member disposed at the mouth portion of the bottle body and including a first sealing portion, the first sealing portion being annularly shaped and including a first hole, one surface of the first sealing portion located toward the bottle body being defined as a first sealing surface which is abutted against the first flat surface of the mouth portion, the first sealing portion including an annular upright portion extending from the first sealing surface, the annular upright portion including an inner surface located in the first hole, and an outer surface which is defined as a second sealing surface to abut against the inner surface of the mouth portion,

the annular upright portion including one end connected to the first sealing portion, and another end of the annular upright portion extending inward to form a second sealing portion which is provided with a second hole in communication with the first hole, a surface of the second sealing portion located toward the second hole being defined as a third sealing surface;

a press member disposed at the outer surface of the mouth portion of the bottle body, one end of the press member extending out to form a pipe portion which is inserted through the first and second holes of the sealing member and into the bottle body, the third sealing surface being abutted against the pipe portion; and

a piston being disposed in the bottle body and including an annular sealing portion abutted against the inner surface of the bottle body, the annular sealing portion including one side located toward the mouth portion and another side located toward the vent hole.

It is learned from the above description that the first sealing surface of the sealing member is closely abutted against the first flat surface of the mouth portion to form a first sealing structure, the second sealing surface of the sealing member is abutted against the inner surface of the mouth portion to form a second sealing structure, and the third sealing surface is abutted against the pipe portion to form a third sealing structure to prevent air from entering the bottle body. With the above three sealing structures, the only thing needs to do during the assembling of the vacuum bottle to create vacuum in the bottle body is to put the sealing member onto the mouth portion and assemble the press member to the mouth portion of the bottle body, without having to apply 10 kg torque. Hence, the cosmetic vacuum bottle of the present invention is easy to assemble and have a better vacuum effect.

### BRIEF DESCRIPTION OF THE DRAWINGS

FIG. 1 is an exploded view of a conventional cosmetic vacuum bottle;

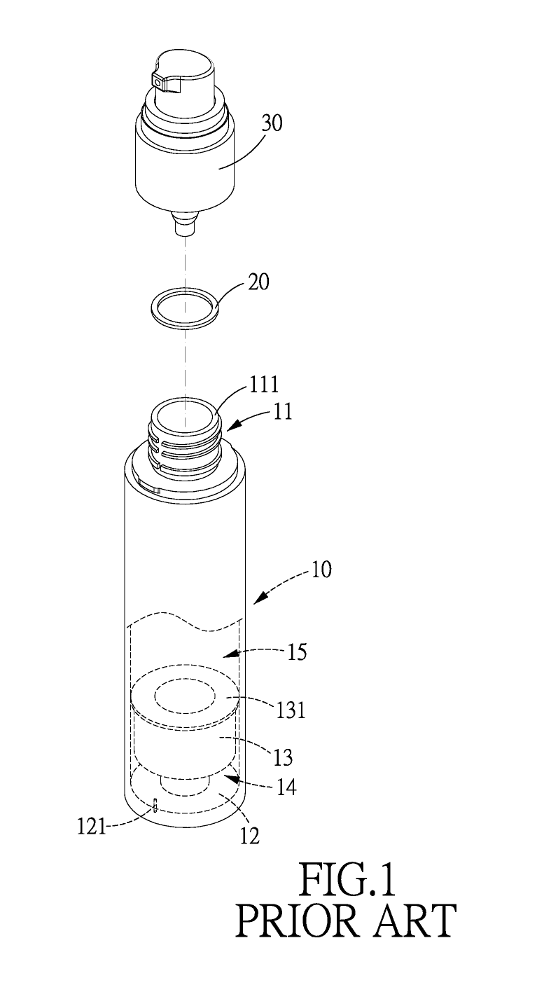

FIG. 2 is an exploded view of a cosmetic vacuum bottle in accordance with the present invention;

FIG. 3 is a cross sectional view of a sealing member in accordance with the present invention;

FIG. 4 is a cross sectional view of the cosmetic vacuum bottle in accordance with the present invention;

FIG. 5 is an exploded view of a cosmetic vacuum bottle in accordance with another embodiment of the present invention; and

FIG. 6 is a cross sectional view of the sealing member in accordance with another embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

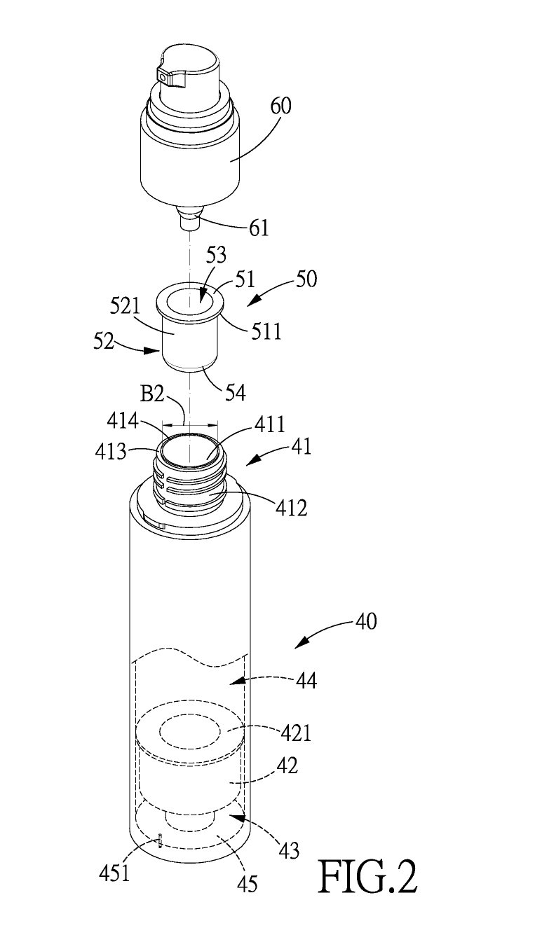

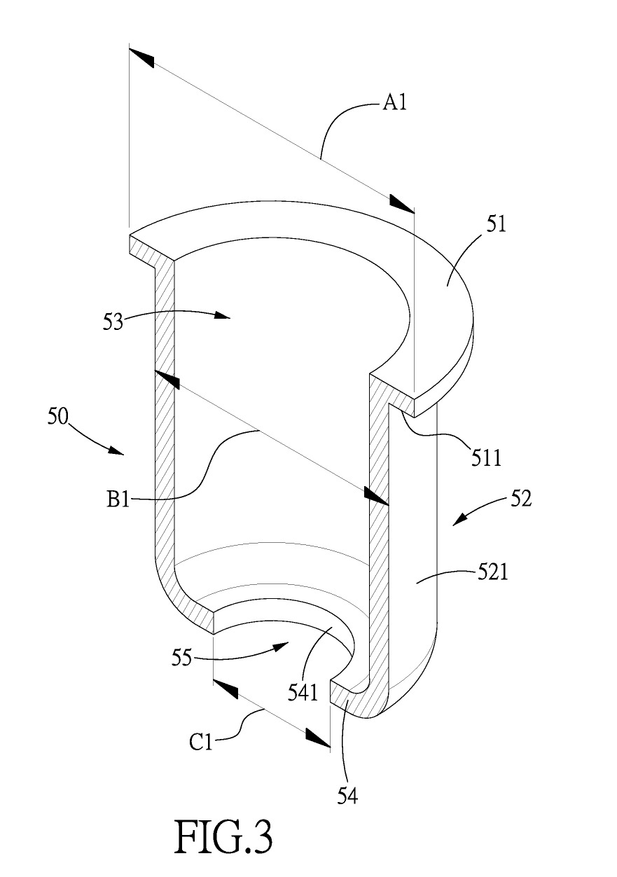

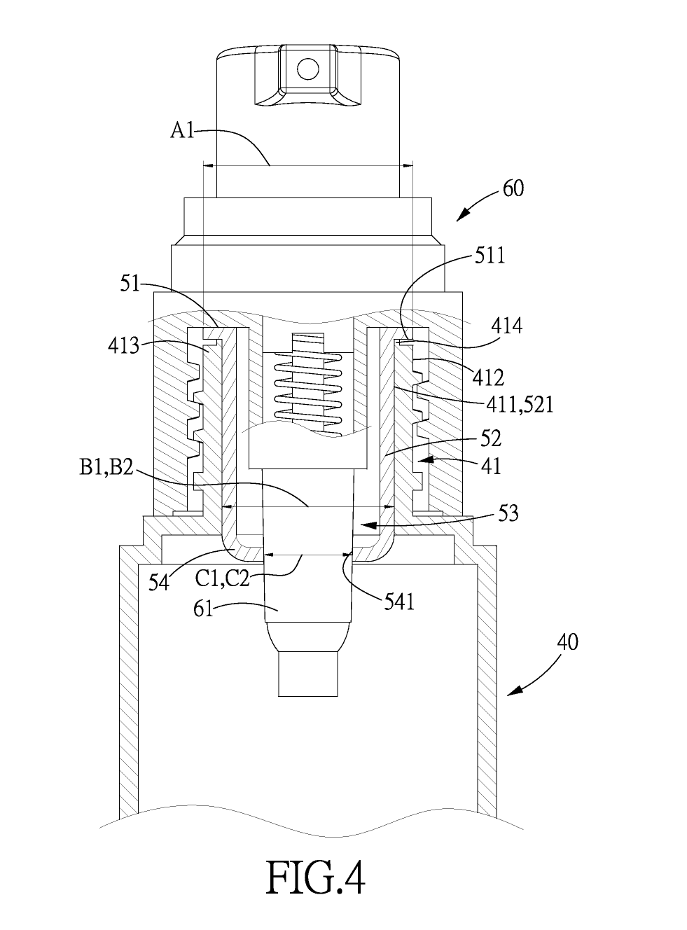

Referring to FIGS. 2-4, a cosmetic vacuum bottle in accordance with the present invention comprises: a bottle body 40, a sealing member 50, and a press member 60.

The bottle body 40 includes a mouth portion 41 at one end thereof. The mouth portion 41 includes an inner surface 411 and an outer surface 412. The mouth portion 41 has one end connected to the bottle body 40, and another end formed with a first flat surface 413. The inner diameter of the mouth portion 41 is defined as a second matching diameter B2. In the bottle body 40 is disposed a piston 42 to divide the bottle body 40 into an air space 43 and a vacuum space 44 which are located at two sides of the piston 42. The piston 42 includes an annular sealing portion 421 closely abutted against the inner surface of the bottle body 40 to isolate the vacuum space 44 from the air space 43. Cosmetic products is contained in the vacuum space 44 and pushed to move by the piston 42. Another end of the bottle body 40 is a bottom surface 45 on which is formed a vent hole 451 which is in communication with the air space 43. Air enters the air space 43 via the vent hole 451 to push the piston 42. The annular sealing portion 421 has one side located toward the mouth portion 41 and another side located toward the vent hole 451.

The sealing member 50 is a cylindrical member disposed at the mouth portion 41 of the bottle body 40 and includes a first sealing portion 51. The first sealing portion 51 is annularly shaped and includes a first hole 53. One surface of the first sealing portion 51 located toward the bottle body 40 is defined as a first sealing surface 511 which is closely abutted against the first flat surface 413 of the mouth portion 41. An outer diameter of the first sealing portion 51 is defined as a first sealing diameter A1.

The first sealing portion 51 includes an annular upright portion 52 extending from the first sealing surface 511. The annular upright portion 52 has an inner surface located in the first hole 53 and an outer surface which is defined as a second sealing surface 521 to closely abut against the inner surface 411 of the mouth portion 41. An outer diameter of the annular upright portion 52 is defined as a second sealing diameter B1 which is equal to the second matching diameter B2. The first sealing diameter A1 is larger than the second sealing diameter B1, so as to improve airtight sealing property.

The annular upright portion 52 has one end connected to the first sealing portion 51, and another end of the annular upright portion 52 extends inward to form a second sealing portion 54 which is provided with a second hole 55 in communication with the first hole 53. A surface of the second sealing portion 54 located toward the second hole 55 is defined as a third sealing surface 541, and the diameter of the second hole 55 is defined as a third sealing diameter C1.

The press member 60 is disposed at the outer surface 412 of the mouth portion 41 of the bottle body 40. One end of the press member 60 extends out to form a pipe portion 61 which is inserted through the first and second holes of the sealing member 50 and into the bottle body 40. The third sealing surface 541 is abutted against the pipe portion 61. A diameter of the pipe portion 61 is defined as a third matching diameter C2 which is equal to the third sealing diameter C1, so as to improve airtight sealing performance. The pipe portion 61 serves to guide cosmetic products out of the vacuum bottle.

In this embodiment, the first flat surface 413 is further provided with a sealing rib 414 to be abutted against the first sealing surface 511.

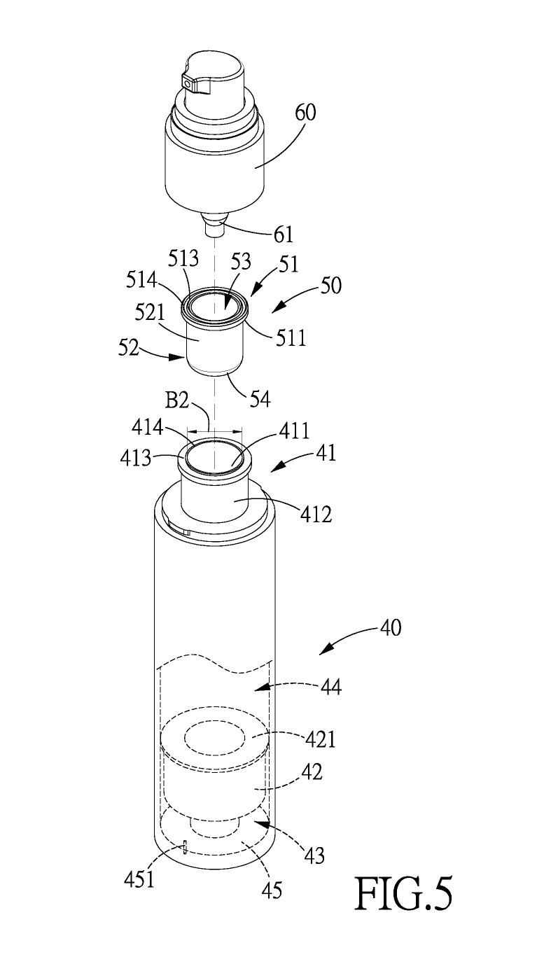

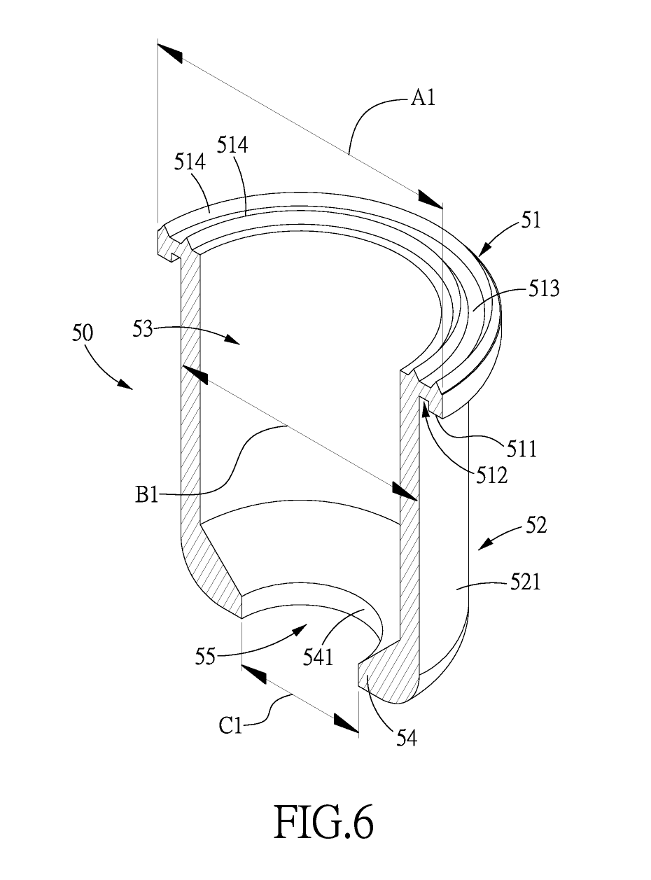

Preferably, as shown in FIGS. 5 and 6, a surface of the first sealing portion 51 located toward the bottle body 40 is defined as a buffering surface 513 which is provided with at least one buffering rib 514, so as to provide a buffering effect when the buffering surface 513 comes into contact with the press member 60. The first sealing surface 511 is further provided with an annular sealing groove 512 for engaging with the sealing rib 414 of the first flat surface 413, so as to further improve the airtight sealing performance.

When the vacuum bottle of the present invention is in use, the user can press the press member 60 to draw the cosmetic products out of the vacuum space 44 of the bottle body 40, so that the part of the vacuum space 44 previously filled with cosmetic products becomes vacuum, and air enters the air space 43 of the bottle body 40 via the vent hole 451 at the bottom surface 45 of the bottle body 40. Since the annular sealing portion isolates the air space 43 from the vacuum space 44 and prevents air of the air space 43 coming into the vacuum space 44, pressure difference will be produced to push the piston 42 to slide within the bottle body 40 to push the cosmetic products contained in the vacuum space 44 of the bottle body 40 toward the press member 60. Therefore, the cosmetic vacuum bottle of the present invention can readily output cosmetic product without using suction pipe.

It is learned from the above description that the first sealing surface 511 of the sealing member 50 is closely abutted against the first flat surface 413 of the mouth portion 41 to form a first sealing structure, the second sealing surface 521 of the sealing member 50 is abutted against the inner surface 411 of the mouth portion 41 to form a second sealing structure, and the third sealing surface 541 is abutted against the pipe portion 61 to form a third sealing structure to prevent air from entering the bottle body 40. With the above three sealing structures, the only thing needs to do during the assembling of the vacuum bottle to create vacuum in the bottle body 40 is to put the sealing member 50 onto the mouth portion 41 and assemble the press member 60 to the mouth portion 41 of the bottle body 40, without having to apply 10 kg torque. Hence, the cosmetic vacuum bottle of the present invention is easy to assemble and have a better vacuum effect.

While we have shown and described various embodiments in accordance with the present invention, it is clear to those skilled in the art that further embodiments may be made without departing from the scope of the present invention.

What is claimed is:

1. A cosmetic vacuum bottle comprising:
a bottle body including a mouth portion at one end thereof, the mouth portion including an inner surface and an outer surface, the mouth portion having one end connected to the bottle body, and another end formed with a first flat surface, another end of the bottle body being a bottom surface on which being formed a vent hole;
a sealing member being a cylindrical member disposed at the mouth portion of the bottle body and including a first sealing portion, the first sealing portion being annularly shaped and including a first hole, one surface of the first sealing portion located toward the bottle body being defined as a first sealing surface which is abutted against the first flat surface of the mouth portion, the first sealing portion including an annular upright portion extending from the first sealing surface, the annular upright portion including an inner surface located in the first hole, and an outer surface which is defined as a second sealing surface to abut against the inner surface of the mouth portion, the annular upright portion including one end connected to the first sealing portion, and another end of the annular upright portion extending inward to form a second sealing portion which is provided with a second hole in communication with the first hole, a surface of the second sealing portion located toward the second hole being defined as a third sealing surface;
a press member disposed at the outer surface of the mouth portion of the bottle body, one end of the press member extending out to form a pipe portion which is inserted through the first and second holes of the sealing member and into the bottle body, the third sealing surface being abutted against the pipe portion; and
a piston being disposed in the bottle body and including an annular sealing portion abutted against the inner surface of the bottle body, the annular sealing portion including one side located toward the mouth portion and another side located toward the vent hole.

2. The cosmetic vacuum bottle as claimed in claim 1, wherein an outer diameter of the first sealing portion is defined as a first sealing diameter, an outer diameter of the annular upright portion is defined as a second sealing diameter which is equal to the second matching diameter, the first sealing diameter is larger than the second sealing diameter, a diameter of the second hole is defined as a third sealing diameter, and a diameter of the pipe portion is defined as a third matching diameter which is equal to the third sealing diameter.

3. The cosmetic vacuum bottle as claimed in claim 1, wherein the first flat surface is provided with a sealing rib to be abutted against the first sealing surface.

4. The cosmetic vacuum bottle as claimed in claim 1, wherein a surface of the first sealing portion located toward the bottle body is defined as a buffering surface which is provided with at least one buffering rib.

5. The cosmetic vacuum bottle as claimed in claim 3, wherein the first sealing surface is further provided with an annular sealing groove for engaging with the sealing rib of the first flat surface.
